(19) United States
(12) Patent Application Publication
(10) Pub. No.: US 2021/0114294 A1
(43) Pub. Date: Apr. 22, 2021

(54) ADDITIVE MANUFACTURING SYSTEM

(71) Applicant: Continuous Composites Inc., Coeur d'Alene, ID (US)

(72) Inventor: Jeremiah R Smith, Coeur d'Alene, ID (US)

(73) Assignee: Continuous Composites Inc., Coeur d'Alene, ID (US)

(21) Appl. No.: 16/947,812

(22) Filed: Aug. 18, 2020

Related U.S. Application Data
(60) Provisional application No. 62/916,763, filed on Oct. 17, 2019.

(51) Int. Cl. B29C 64/209; B33Y 30/00; B33Y 50/02; B33Y 10/00; B33Y 80/00; B29C 64/393; B29C 64/118; B29C 70/38; B29C 64/165; B33Y 70/10; B64F 5/10

(52) U.S. Cl. CPC B29C 64/209; B33Y 30/00; B33Y 50/02; B33Y 10/00; B33Y 80/00; B29L 2031/3076; B29C 64/118; B29C 70/384; B29C 64/165; B33Y 70/10; B64F 5/10; B29C 64/393

(57) ABSTRACT

A system is disclosed for additively manufacturing a structure. The system may include a support and a discharge head connected to and moved by the support. The discharge head may have a wetting mechanism configured to apply a matrix to a continuous reinforcement, an outlet configured to discharge the matrix-wetted continuous reinforcement, and a cure enhancer configured to expose the matrix to a cure energy at discharge. The system may also include a dispenser mounted to the discharge head and configured to selectively advance particles toward at least one of the matrix and the continuous reinforcement, and a processor programmed to regulate the dispenser and affect a parameter linked to the particles in a variable manner along at least a length of the continuous reinforcement.

### RELATED APPLICATION

This application is based on and claims the benefit of priority from U.S. Provisional Application No. 62/916,763 that was filed on Oct. 17, 2019, the contents of which are expressly incorporated herein by reference.

### TECHNICAL FIELD

The present disclosure relates generally to a manufacturing system and, more particularly, to a system for additively manufacturing a composite structure.

### BACKGROUND

Continuous fiber 3D printing (a.k.a., CF3D®) involves the use of continuous fibers that are at least partially coated with a matrix inside of a movable print head, just prior to discharge from the print head. The matrix can be a thermoplastic, a thermoset, a powdered metal, or a combination of any of these and other known matrices. Upon exiting the print head, a head-mounted cure enhancer (e.g., a UV light, an ultrasonic emitter, a heat source, a catalyst supply, etc.) is activated to initiate and/or complete curing of the matrix. This curing occurs almost immediately, allowing for unsupported structures to be fabricated in free space, without the need for a mold or an autoclave. An example of this technology is disclosed in U.S. Pat. No. 9,511,543 that issued to Tyler on Dec. 6, 2016 (“the '543 patent”). CF3D® may be inexpensive, fast, and efficient, as the use of autoclaves, molds, and manual labor associated with traditional composite manufacturing may be reduced or even eliminated.

Although CF3D® may be an inexpensive, fast, and efficient way to produce high-strength and low-weight structures, improvements can be made to the structure and/or operation of existing systems. For example, some applications may benefit from material flexibilities not afforded by existing systems. The disclosed additive manufacturing system and method are uniquely configured to provide these flexibilities and/or to address other issues of the prior art.

### SUMMARY

In one aspect, the present disclosure is directed to an additive manufacturing system. The system may include support and a discharge head connected to and moved by the support. The discharge head may have a wetting mechanism configured to apply a matrix to a continuous reinforcement, an outlet configured to discharge the matrix-wetted continuous reinforcement, and a cure enhancer configured to expose the matrix to a cure energy at discharge. The system may also include a dispenser mounted to the discharge head and configured to selectively advance particles toward at least one of the matrix and the continuous reinforcement, and a processor programmed to regulate the dispenser and affect a parameter linked to the particles in a variable manner along at least a length of the continuous reinforcement.

In another aspect, the present disclosure is directed to a method of additively manufacturing a structure. The method may include wetting a continuous reinforcement with a matrix, discharging the wetted continuous reinforcement through an outlet of a print head, moving the print head during discharging, and exposing the matrix to a cure energy during discharging. The method may also include selectively advancing particles toward at least one of the matrix and the continuous reinforcement to affect a parameter of the structure linked to the particles in a variable manner along at least a length of the continuous reinforcement.

### BRIEF DESCRIPTION OF THE DRAWINGS

FIG. 1 is a diagrammatic illustration of an exemplary disclosed manufacturing system;

FIGS. 2-7 are is a cross-sectional illustrations of an exemplary disclosed discharge heads that may be used in conjunction with the manufacturing system of FIG. 1;

FIGS. 8 and 9 are cross-sectional illustrations of an exemplary disclosed structure that may be fabricated with the manufacturing system of FIGS. 1; and

FIG. 10 is an isometric illustration of an exemplary application for the structure of FIGS. 8 and 9.

### DETAILED DESCRIPTION

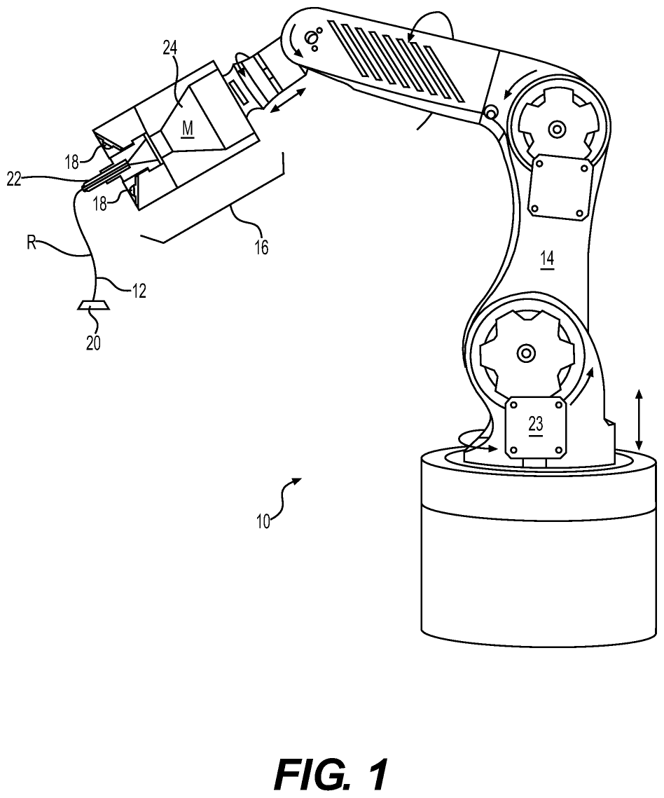

FIG. 1 illustrates an exemplary system 10, which may be used to manufacture a composite structure 12 having any desired shape. System 10 may include a support 14 and one or more deposition heads (“head”) 16. Head(s) 16 may be couplable to and movable by support 14. In the disclosed embodiment of FIG. 1, support 14 is a robotic arm capable of moving head(s) 16 in multiple directions during fabrication of structure 12. Support 14 may alternatively embody a gantry (e.g., an overhead bridge or single-post gantry) or a hybrid gantry/arm also capable of moving head(s) 16 in multiple directions during fabrication of structure 12. Although support 14 is shown as being capable of 6-axis movements, it is contemplated that support 14 may be capable of moving head(s) 16 in a different manner (e.g., along or around a greater or lesser number of axes). In some embodiments, a drive may mechanically couple head(s) 16 to support 14, and include components that cooperate to move portions of and/or supply power or materials to head 16.

Each head 16 may be configured to receive or otherwise contain a matrix (shown as M in FIG. 1). The matrix may include any type of matrix (e.g., a liquid resin, such as a zero-volatile organic compound resin, a powdered metal, etc.) that is curable. Exemplary resins include thermosets, single- or multi-part epoxy resins, polyester resins, cationic epoxies, acrylated epoxies, urethanes, esters, thermoplastics, photopolymers, polyepoxides, thiols, alkenes, thiolenes, and more. In one embodiment, the matrix inside head 16 may be pressurized, for example by an external device (e.g., by an extruder, a pump, etc.—not shown) that is fluidly connected to head 16 via a corresponding conduit (not shown). In another embodiment, however, the pressure may be generated completely inside of head 16 by a similar type of device. In yet other embodiments, the matrix may be gravity-fed into and/or through head 16. For example, the matrix may be fed into head 16, and pushed or pulled out of head 16 along with one or more continuous reinforcements (shown as R in FIG. 1). In some instances, the matrix inside head 16 may need to be kept cool and/or dark in order to inhibit premature curing or otherwise obtain a desired rate of curing after discharge. In other instances, the matrix may need to be kept warm and/or illuminated for similar reasons. In either situation, head 16 may be specially configured (e.g., insulated, temperature-controlled, shielded, etc.) to provide for these needs.

The matrix may be used to coat any number of continuous reinforcements (e.g., separate fibers, tows, rovings, socks, and/or sheets of continuous material) and, together with the reinforcements, make up a portion (e.g., a wall) of composite structure 12. The reinforcements may be stored within or otherwise passed through head 16 (e.g., fed from one or more spools—not shown). When multiple reinforcements are simultaneously used, the reinforcements may be of the same material composition and have the same sizing and cross-sectional shape (e.g., circular, square, rectangular, etc.), or a different material composition with different sizing and/or cross-sectional shapes. The reinforcements may include, for example, carbon fibers, vegetable fibers, wood fibers, mineral fibers, glass fibers, plastic fibers, metallic wires, optical tubes, etc. It should be noted that the term “reinforcement” is meant to encompass both structural and non-structural (e.g., functional) types of continuous materials that are at least partially encased in the matrix discharging from head 16.

The reinforcements may be exposed to (e.g., at least partially coated with) the matrix while the reinforcements are inside head 16, while the reinforcements are being passed to head 16, and/or while the reinforcements are discharging from head 16. The matrix, dry (e.g., unimpregnated) reinforcements, and/or reinforcements that are already exposed to the matrix (pre-impregnated reinforcements) may be transported into head 16 in any manner apparent to one skilled in the art. In some embodiments, a filler material (e.g., chopped fibers, nano particles or tubes, etc.) may be mixed with the matrix before and/or after the matrix coats the continuous reinforcements.

One or more cure enhancers (e.g., a UV light, an ultrasonic emitter, a laser, a heater, a catalyst dispenser, etc.) 18 may be mounted proximate (e.g., within, on, and/or adjacent) head 16 and configured to enhance a cure rate and/or quality of the matrix as it is discharged from head 16. Cure enhancer 18 may be controlled to selectively expose portions of structure 12 to energy (e.g., UV light, electromagnetic radiation, vibrations, heat, a chemical catalyst, etc.) during material discharge and the formation of structure 12. The energy may trigger a chemical reaction to occur within the matrix, increase a rate of the chemical reaction, sinter the matrix, harden the matrix, or otherwise cause the matrix to partially or fully cure as it discharges from head 16. The amount of energy produced by cure enhancer 18 may be sufficient to at least partially cure the matrix before structure 12 axially grows more than a predetermined length away from head 16. In one embodiment, structure 12 is cured sufficient to hold its shape before the axial growth length becomes equal to an external diameter of the matrix-coated reinforcement.

The matrix and/or reinforcement may be discharged from head 16 via at least two different modes of operation. In a first mode of operation, the matrix and/or reinforcement are extruded (e.g., pushed under pressure and/or mechanical force) from head 16, as head 16 is moved by support 14 to create features of structure 12. In a second mode of operation, at least the reinforcement is pulled from head 16, such that a tensile stress is created in the reinforcement during discharge. In this mode of operation, the matrix may cling to the reinforcement and thereby also be pulled from head 16 along with the reinforcement, and/or the matrix may be discharged from head 16 under pressure along with the pulled reinforcement. In the second mode of operation, where the matrix is being pulled from head 16 with the reinforcement, the resulting tension in the reinforcement may increase a strength of structure 12 (e.g., by aligning the reinforcements, inhibiting buckling, etc.) after curing of the matrix, while also allowing for a greater length of unsupported structure 12 to have a straighter trajectory. That is, the tension in the reinforcement may act against the force of gravity (e.g., directly and/or indirectly by creating moments that oppose gravity) to provide support for structure 12. In some embodiments, the tension may also help impregnate the reinforcement with matrix (e.g., in pressure-based impregnation applications).

The reinforcement may be pulled from head 16 as a result of head 16 being moved by support 14 away from an anchor 20. In particular, at the start of structure formation, a length of matrix-impregnated reinforcement may be pulled and/or pushed from head 16, deposited onto anchor 20, and cured, such that the discharged material adheres (or is otherwise coupled) to anchor 20. Thereafter, head 16 may be moved away from anchor 20, and the relative movement may cause the reinforcement to be pulled from head 16. It should be noted that the movement of reinforcement through head 16 could be assisted via internal feed mechanisms (not shown), if desired. However, the discharge rate of reinforcement from head 16 may primarily be the result of relative movement between head 16 and anchor 20, such that tension is created within the reinforcement. As discussed above, anchor 20 could be moved away from head 16 instead of or in addition to head 16 being moved away from anchor 20.

As can be seen in FIG. 1, head 16 may include, among other things, an outlet 22 and a matrix reservoir 24 located upstream of outlet 22. In this example, outlet 22 is a single-channel nozzle configured to discharge composite material having a generally circular, tubular, or rectangular cross-section. The configuration of head 16, however, may allow outlet 22 to be swapped out for another outlet (not shown) that discharges composite material having a different shape (e.g., a flat or sheet-like cross-section, a multi-track cross-section, etc.). Fibers, tubes, and/or other reinforcements may pass through matrix reservoir 24 and be wetted (e.g., at least partially coated and/or fully saturated) with matrix prior to discharge. Any type of wetting mechanism(s) known in the art (e.g., a bath—shown, an injector, a pressure-based applicator, etc.) may be associated with matrix reservoir 24.

One or more controllers 23 may be provided and communicatively coupled with support 14 and head 16. Each controller 23 may embody a single processor or multiple processors that are programmed to control an operation of system 10. Controller 23 may include one or more general or special purpose processors or microprocessors. Controller 23 may further include or be associated with a memory for storing data such as, for example, design limits, performance characteristics, operational instructions, tool paths, and corresponding parameters of each component of system 10. Various other known circuits may be associated with controller 23, including power supply circuitry, signal-conditioning circuitry, solenoid driver circuitry, communication circuitry, and other appropriate circuitry. Moreover, controller 23 may be capable of communicating with other components of system 10 via wired and/or wireless transmission.

One or more maps may be stored in the memory of or otherwise be accessible by controller 23 and used during fabrication of structure 12. Each of these maps may include a collection of data in the form of lookup tables, graphs, and/or equations. In the disclosed embodiment, the maps may be used by controller 23 to determine movements of head 16 required to produce desired geometry (e.g., size, shape, material composition, performance parameters, and/or contour) of structure 12, and to regulate operation of cure enhancer(s) 18 and/or other related components in coordination with the movements.

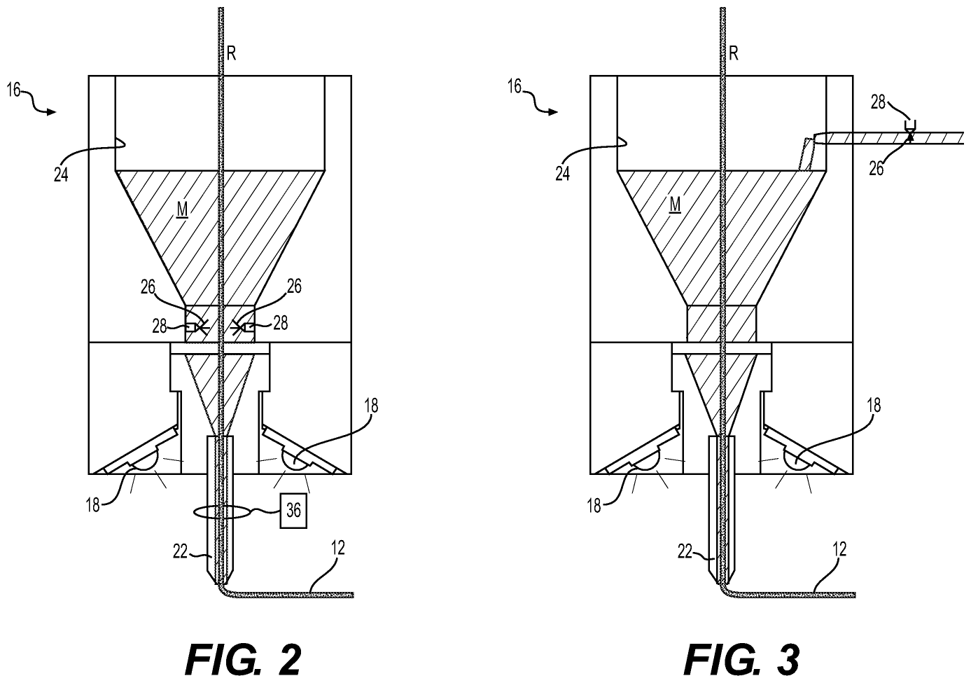

An exemplary head 16 is illustrated in FIG. 2. In this embodiment, head 16 may be configured to discharge composite material having one or more properties that vary along a length, arc angle, and/or radial dimension of the reinforcement in the material. These properties may include one or more of the following: magnetic permeability, magnetic susceptibility, magnetic flux, magnetic flux density, flux linkage, magnetomotive force, magnetic reluctance, magnetic complex reluctance, magnetic impedance, effective resistance, magnetic inductivity, magnetic capacitively, luminosity, electrical conductivity, electrical resistivity, electrical resistance, electrical impedance, electrolytic conductivity, semi-conductivity, super-conductivity, thermoelectric properties, mass, density, thermal control/directionality, translucence, and others.

To facilitate this linear and/or radial change in property, head 16 may include one or more devices that function to selectively apply and/or distribute property-affecting particles (e.g., nanoparticles, nanotubes, nano-scale crystalline and crystal lattice structures, various polymorphs of nano scale compounds, pure elements, amorphous compounds, elemental forms etc.—“particles”) 26 onto and/or inside of the composite material prior to, during, and/or just after discharge through outlet 22. These particles 26 may include, among other things, semiconductors, metal oxides, metal nitrides, metal chalcogenides, fluorides, sulphides, graphene, graphite, ceramics, metals, clays, refractory materials, and/or polymorphs of any of the above materials. In the embodiment of FIG. 2, head 16 includes one or more particle dispensers (“dispensers”) 28 located inside of head 16 (e.g., inside of matrix reservoir 24 and/or outlet 22). Each dispenser 28 may be configured to advance a particular type of particle 26. In one example, particles 26 are advanced by dispenser(s) 28 into the matrix inside of head 16 (e.g., within a localized region, such as at a discharge end of reservoir 24 and/or an entrance to outlet 22), such that the particles coat and/or become entrained within the reinforcement (e.g., dispersed between fibers of the reinforcement) being wetted with matrix at that location. Particular dispensers 28 may be selectively activated at particular times and/or for particular durations, such that a desired amount and/or density of particles 26 are dispensed at particular locations along a length of the reinforcement, a particular arc angle around the reinforcement, and/or at particular radial (e.g., axial offset) location of reinforcement.

Dispenser 28 may take any form suitable for advancing particles 26 in a controlled manner. In one embodiment, dispenser 28 is a pumping device (e.g., a piezo pump, an electrostatic pump, a pneumatic pump, etc.) that moves dry particles, particle droplets, a particle slurry, an atomization of particles and/or particle mixture, or another form of particles 26. In another embodiment, dispenser 28 may include a pressurized source (e.g., a constant or selectively generated source) of particles that can be metered (e.g., via selective connection). Other forms of dispensers are also considered.

Another exemplary head 16 is illustrated in FIG. 3. In this embodiment, one or more dispensers 28 are located upstream of matrix reservoir 24. For example, dispenser(s) 28 are located to affect a quantity and or distribution of particles entering and/or within matrix reservoir 24, as a whole. While functional, this arrangement may not provide the granularity in particle distribution control offered by the embodiment of FIG. 2.

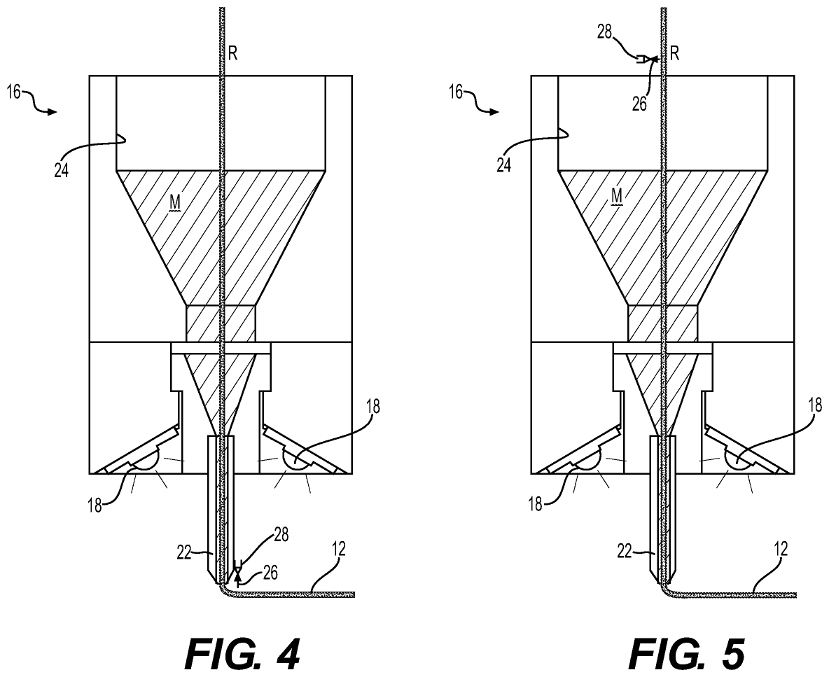

Another exemplary head 16 is illustrated in FIG. 4. In this embodiment, one or more dispensers 28 are located outside of head 16, but still connected to head 16. For example, dispenser(s) 28 may be located adjacent outlet 22 and configured to advance particles 26 towards the material discharging from outlet 22. In this example, dispenser(s) 28 may be configured to advance particles 26 towards only an exposed side of the discharging material. In other words, a side of the material overlapping an underlying layer may not be accessible in the embodiment of FIG. 4. In one embodiment, particles 26 may be applied to the discharging material prior to exposure of the material to energy from cure enhancer(s) 18.

Another exemplary head 16 is illustrated in FIG. 5. In this embodiment, one or more dispensers 28 are located upstream of matrix reservoir 24. In this example, dispenser(s) 28 may be configured to advance particles toward the reinforcement (R) prior to the reinforcement being initially or finally wetted by the matrix (M). With this arrangement, the matrix subsequently applied to the reinforcement may provide a coating that that helps to protect, insulate, and/or shield particles 26.

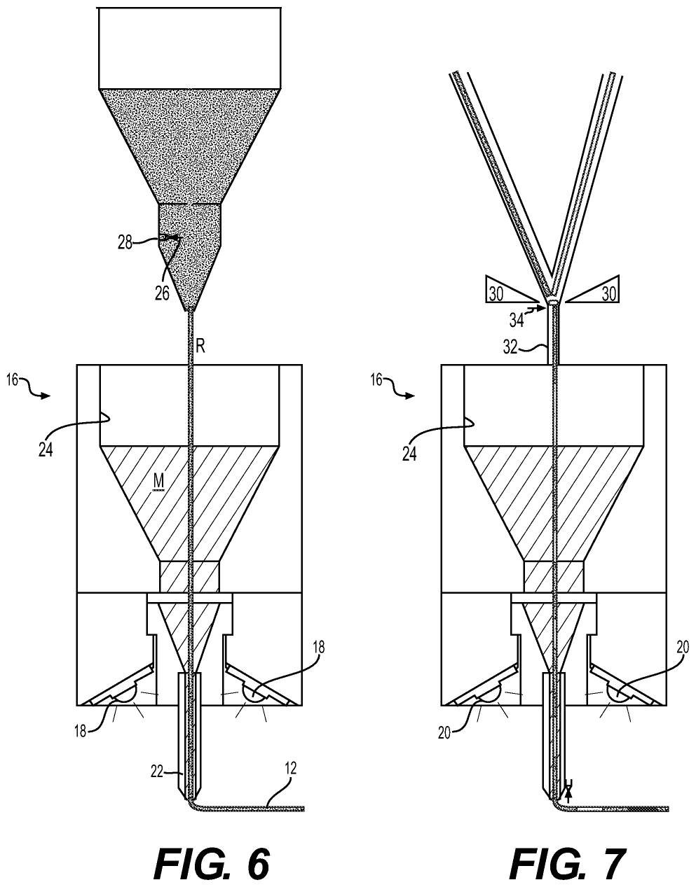

Another embodiment of head 16 is illustrated in FIG. 6. In this embodiment, particles 26 may be applied by dispenser(s) 28 during formulation of the reinforcements and prior to any matrix coating. For example, the particles 26 may be applied to, embedded within or otherwise mixed into precursors of the reinforcements.

In a final embodiment of head 16, dispensers 28 may be omitted. Instead, two different reinforcements having different desired properties may be selectively segmented and aligned end-to-end prior to being wetted with matrix. To facilitate this operation, one or more cutting mechanisms 30 may be located at an intersection of the two reinforcements. Cutting mechanism(s) 30 may be configured to selectively cut a first or a second of the reinforcements to a desired segment length, prior to the cut segments being directed through a feed channel 32 into matrix reservoir 24. In some embodiments, the segments of reinforcement may be adhered to each other, such that discharge of material through outlet 22 results in a continuous reinforcement being fed (e.g., pushed and/or pulled) into reservoir 24. An adhesive dispenser 34 may be provided for this purpose.

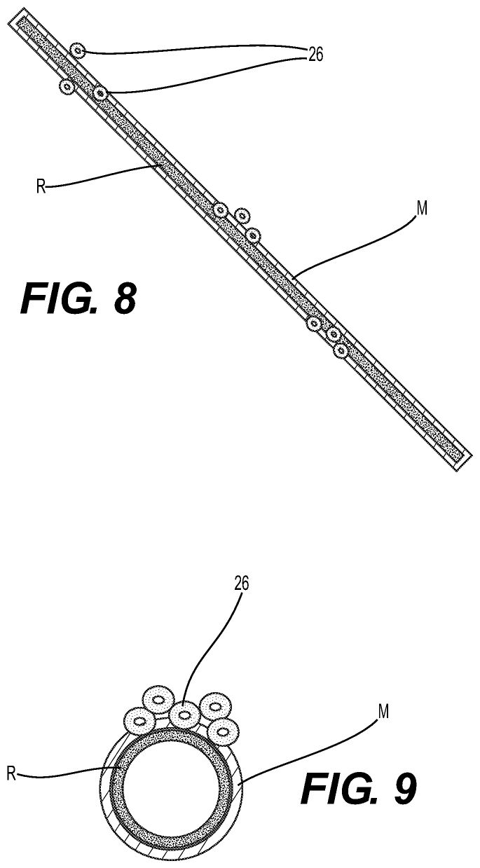

FIGS. 8 and 9 illustrate an exemplary material that has been discharged from head 16, including a continuous reinforcement, matrix, and particles 26. As seen in FIG. 8, particles 26 may be applied to the material at desired locations along a length of the continuous reinforcement, at desired distances from a center axis of the reinforcements, with a desired density, and at a desired side of the reinforcement to impart desired characteristics to the material at desired locations within structure 12. As seen in FIG. 9, particles 26 may be applied at a desired arc angle, relative to an axis of the reinforcement.

Controller 23 may be communicatively coupled with dispensers 28, cutting mechanism 30, and/or adhesive dispenser 34 to regulate operations thereof. For example, based on known kinematics of system 10, known geometry of structure 12, and desired properties of portions of structure 12, controller 23 may selectively activate dispenser(s) 28, cutting mechanism 30, and/or adhesive dispenser 34 to advance specific particles 26 in a manner that achieves the desired size, shape, contours, and properties of structure 12.

In some embodiments, it may be important to orient individual particles 26 in a certain way, for example to affect magnetic and/or conductive properties. This orientation may be accomplished in several ways, after advancement of particles 26 to the matrix, reinforcement, and/or matrix-wetted reinforcement by dispenser(s) 28. For example, magnetic particles 26 may be oriented in a particular direction by applying a magnetic field to localized areas of head 16 (e.g., inside and/or outside of matrix reservoir 24 and/or outlet 22), prior to full curing of the matrix. The magnetic field may be regulated to cause desired movement of particles 26. Subsequent curing of the matrix may then retain particles 26 at a desired position and/or orientation. In some applications, a temporary curing process may be implemented (e.g., upstream and/or inside of matrix reservoir 24 and/or outlet 22), wherein the matrix is cured only enough to retain the desired position and/or orientation of particles 26, with cure enhancers 18 providing a full curing at discharge from outlet 22. Heating, cooling, voltage application, and/or electrical fields generated at localized areas may also impact particle concentration and/or dispersion. A particle positioning and/or orienting device 36 (shown only in FIG. 2) may be used for this purpose.

### INDUSTRIAL APPLICABILITY

The disclosed system may be used to continuously manufacture composite structures having any desired cross-sectional shape, length, density, strength, or other performance parameter discussed above. The composite structures may include any number of different reinforcements of the same or different types, diameters, shapes, configurations, and consists, any number and types of different matrices. In addition, the disclosed system may allow for dynamic use of a variety of different particles 26 at different locations and densities. Operation of system 10 will now be described in detail.

At a start of a manufacturing event, information regarding a desired structure 12 may be loaded into system 10 (e.g., into controller 23 that is responsible for regulating operation of support 14, head 16, cure enhancer(s) 18, dispenser(s) 28, cutting mechanism(s) 30, and/or adhesive dispenser(s) 34). This information may include, among other things, a size (e.g., diameter, wall thickness, length, etc.), a contour (e.g., a trajectory), surface features (e.g., ridge size, location, thickness, length; flange size, location, thickness, length; etc.), connection geometry (e.g., locations and sizes of couplings, tees, splices, etc.), location-specific matrix stipulations, location-specific reinforcement stipulations, desired cure rates, cure locations, cure parameters, desired performance parameters, distribution of particles 26, etc. It should be noted that this information may alternatively or additionally be loaded into system 10 at different times and/or continuously during the manufacturing event, if desired.

Based on the component information, and one or more different (e.g., different sizes, shapes, and/or types of) reinforcements, matrix materials, and/or particles 26 may be selectively installed within system 10, supplied into matrix reservoir 24, and/or supplied to dispenser(s) 28. For example, a flat ribbon of generally transparent fiberglass material or a round tow of generally opaque carbon fibers may be threaded through head 16. In some embodiments, the reinforcements may also need to be connected to a pulling machine (not shown) and/or to a mounting fixture (e.g., to anchor 20). Installation of the matrix material may include connection of one or more supplies with matrix reservoir 24. Likewise, installation of particles 26 may include connection of one or more supplies with dispenser(s) 28. Controller 23 may then selectively activate a particular combination of dispensers 28, such that the continuous reinforcement passing through head 16 is appropriately coated and/or embedded with particles 26 before and/or after the reinforcement is wetted with matrix. Head 16 may then be moved by support 14 under the regulation of controller 23 to cause the matrix-coated reinforcements to be placed against or on a corresponding anchor 20.

Cure enhancers 18 may then be selectively activated (e.g., turned on/off, aimed, overlapped, and/or intensity-adjusted by controller 23) to cause hardening of the matrix material surrounding the reinforcements and/or particles 26, thereby bonding the material to anchor 20. Controller 23 may thereafter cause support 14 to move head away from anchor 20, thereby causing matrix-coated reinforcements to be pulled from head 16 along a desired trajectory. Cure enhancers 18 may be active at this time, such that the matrix coated the reinforcements are at least partially cured. It should be noted that particles 26 could alternatively or additionally be applied to the composite material after at least partial curing of the matrix material by cure enhancers 18, if desired. In some embodiments, the curing effected by enhancers 18 may be almost immediate, such that the reinforcements may be supported in free-space by the hardened matrix.

At any time during formation of structure 12, controller 23 may implement a dynamic application and/or switching of particles 26, thereby changing properties of specific areas of structure 12. For example, controller 23 may activate dispenser(s) 28 to cause particles 26 being advanced thereby to be increased, reduced, stopped, and/or relocated. This may help to improve desired properties of structure 12. Once structure 12 has grown to a desired length, structure 12 may be disconnected (e.g., severed) from head 16 in any desired manner.

In some applications, an optimization process may be implemented to affect an optimal shape of structure 12 in conjunction with an optimal placement of particles 26. For example, controller 23 (or another offboard controller—not showing) may be configured to analyze a predetermined shape of structure 12, a predetermined layout of reinforcements (e.g., structural and/or functional reinforcements), and a predetermined distribution of particles 26 within structure 12 to determine if specified mechanical and geometric properties of structure 12 are satisfied, while simultaneously minimizing interruption of or even enhancing the particle-imparted properties. For instance, when fabricating an antenna, the mechanical and/or geometric properties iteration loop could be implemented first, thereby providing an estimate of where and in what concentration to place specific particles 26 (e.g., in response to results from finite element analysis). Thereafter a design of the antenna (e.g., placement of particles 26) may be optimized while being constrained to ‘live’ only where there is material from the mechanical/geometric properties loop. In that way, all of the properties may be optimized, while ensuring that the antenna can be fabricated (e.g., that particles are placed only where you have particular structural and/or functional reinforcements).

In some applications, care may be taken to ensure that particles 26 are dispersed and/or suspended with the matrix until curing of the matrix. This will help to fix particles 26 at desired locations, densities, and/or distributions. In one example, print head 16 and/or only the matrix containing particles 26 may be mechanically agitated in a desired manner to maintain a desired state of particles 26. This may be achieved, for instance, via one or more ultrasonic emitters (not shown) that create waves within the matrix. Each area of print head 16 and/or the matrix may receive a time and amplitude changing ultrasonic vibration (sonication), the force of the vibration overcoming weaker nuclear forces and other factors that would otherwise allow the material to agglomerate. Other forms of mechanical agitation might be induced via process-mixing hardware (blades, screws, etc.) or A-stable motors. Use of higher-viscosity carriers may also slow/stop migration and agglomeration of particles 26 during processing.

In another example, particles 26 could be inhibited from agglomerating via a chemical solution. For example, each particle could be coated in a surfactant that lowers a surface tension on each particle. Alternatively, a chemical additive could be mixed into the matrix-particle material within head 16 that inhibits agglomeration. This additive could include, for example, a steric stabilizer, a lignin, etc.

The disclosed system may impart functionality to structure 12 that was heretofore unavailable. For example, structure 12, with the correct placement of specific particles 26, may provide for light diffusing, reflecting, and/or shadowing functionality. Similarly, structure 12 may provide for electromagnetic shielding (e.g., via formation of a high-wavelength AC signal wire), impedance matching of printed 2-port circuits, printed integrated ground planes, in-situ printed coaxial cladding, in-situ printed fiber optic grating and/or cladding, printed capacitive decoupling for adjacent power and/or signal lines, impedance matching stub printing for printed transmission lines, etc.

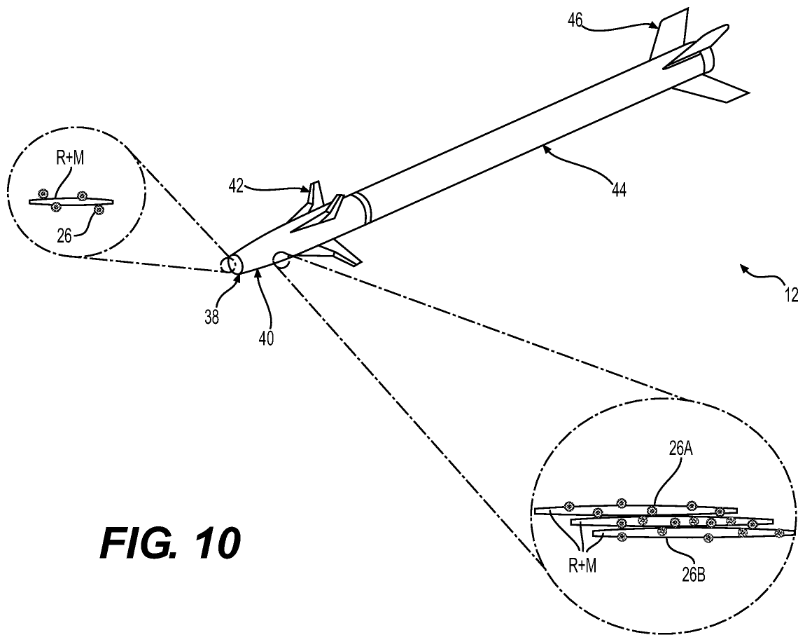

An exemplary application of the disclosed concepts is depicted in FIG. 10. In this application, the structure 12 fabricated via system 10 (referring to FIG. 1) is a missile or other aircraft having radar absorbing technology. It is contemplated, however, that structure 12 of FIG. 10 could alternatively embody ground-based military hardware, if desired.

Traditionally, military hardware has been provided with radar absorbing technology via application of an outer layer or coating of absorbing material. For example, a textile (e.g., a polyacrylonitrile fabric) having pores filled with magnetic metal nanoparticles (e.g., via a liquid deposition process) and over-coated with a liquid polymer for protection would be adhered to an outer layer of an otherwise structurally complete component. The magnetic metal nanoparticles would reduce reflection of microwaves striking the outer layer and/or generate loss of the microwaves during propagation through the outer layer.

While traditional radar absorbing technology may be acceptable for some applications, it may also be problematic. First, because the outer layer of absorbing material is applied to an already structurally complete component, the outer layer increases a capital cost, weight, and operational cost of the component. Second, application of the outer layer could introduce an additional (i.e., second reflection) wave that can be detected by a corresponding receiver. That is, a first reflection wave is generated when the original microwave reflects off the outer layer, and a second reflection wave may be generated when a portion of the original wave passes through the outer layer and reflects off the outer surface of the structurally complete inner component. Multiple waves may increase a likelihood of reflected-wave detection. Third, application of the outer layer of fabric to the inner component may be labor intensive and provide opportunities for error and detectable discontinuities. Fourth, the outer layer may be tuned to only a single microwave wavelength, potentially limiting the use of the component.

In the disclosed embodiment of FIG. 10, structure 12 may be fabricated by system 10 from structural reinforcements R, structural and/or wave-absorbing matrix(es) M, and absorbing nano-particles 26, all at the same time. That is, further steps to add extra layers of non-structural absorbing material to an already structurally complete component may not be required. This may reduce the capital cost, weight, and operating cost of structure 12. In addition, the second refection wave discussed above may be reduced or even eliminated. The matrix and/or nano-particles may be tuned for any number of microwave wavelengths and/or tuned for different wavelengths at different locations of structure 12.

In the embodiment of FIG. 10, structure 12 may include an IR dome or nose cone 38 at a leading end, a control group 40 connected to and trailing IR dome 38, fins 42 affixed to an outer surface of control group 40, a motor 44 connected to and trailing control group 40, and wings 46 affixed to an outer surface of motor 44. It should be noted that structure 12 could include additional, different and/or fewer components (e.g., a payload, hangers, etc.), if desired. Some portions of these components (e.g., external facing surfaces) may be more susceptible to detection via radar, while other portions (e.g., internal electronics, munitions, etc.) may be more susceptible to thermal damage (e.g., when passing out of and/or into the atmosphere). Accordingly, care should be taken when fabricating these components via system 10 to shield against these risks.

In one embodiment, the external surfaces of structure 12 may be fabricated by system 10 to have a geometry (e.g., thickness and/or contour) that reduces reflectively and by using nano-particles (i.e., specially selected particles in addition to continuous structural reinforcements and matrix) 26a having a wave impedance tuned to wavelength(s) of microwaves expected to be encountered by structure 12. The nano-particles 26 may be selected, for example, from any one or more of Iron, Nickel, Cobalt, Magnesium, Zinc, and their alloys. In this same embodiment, the portions of structure 12 more susceptible to thermal damage may alternatively or additionally include nano-particles 26b having higher resistance to thermal shock-loading (e.g., boron-nitride or another ceramic).

In one embodiment, nano-particles 26 may be suspended within the matrix and tuned for one or more particular wavelengths. For example, a unit of matrix (e.g., a voxel) may include a specified amount (e.g., number and size(s)) of nano-particles 26 that corresponds with a targeted wavelength that is to be absorbed. For the purposes of this disclosure, the voxel with the associated amount of a nano-particles 26 contained therein may be considered a voxel concentration (V_{c}). In the disclosed embodiment, the V_{c} associated with a particular nano-particle 26 required to adequately suppress a particular wavelength may be generally proportional (e.g., have a linear relationship) to the wavelength according to the following equation EQ-1 below:

V_{c}=f(c/f) EQ-1

wherein:
Vc is the voxel concentration;
c is the speed of light; and
f is the targeted radio frequency.

While a particular layer of material being discharged by system 10 during fabrication of structure 12 may be tuned to one or more wavelengths, it is contemplated that multiple layer that are each tuned to a different wavelength may alternatively or additionally be stacked. For example, a first layer of discharged material tuned to a particular wavelength could be overlapped with a second layer of discharged material tuned to a different wavelength. In this way, multiple layers with different concentrations of ferritic material could be stacked to create a more broad-band absorber (allowing a wider range of frequencies to be absorbed for broader deployment in multiple theaters with different microwave signals). It is contemplated that any number of layers of material having any number of different voxel concentrations could be stacked to any desired thickness.

In addition to being selected for wave absorption, nano-particles 26 could be selected and added to the material discharged from head 16 for other purposes. For example, boron-nitride nano-particles 26 may be added into the matrix to stabilize operation of structure 12 within a range of environmental temperatures (e.g., during transition into and out of the atmosphere). In the example illustrated in FIG. 10, radar dome 38 may include only a single layer of material having only ferritic nano-particles, while controls group . may include multiple layers of both ferritic and ceramic particles 26 (e.g., an outer layer of only ferritic nano-particles, an inner layer of only ceramic particles, and an intermediate layer with both ferritic and ceramic particles).

It will be apparent to those skilled in the art that various modifications and variations can be made to the disclosed system and method. Other embodiments will be apparent to those skilled in the art from consideration of the specification and practice of the disclosed system and method. It is intended that the specification and examples be considered as exemplary only, with a true scope being indicated by the following claims and their equivalents.

What is claimed is:

1. An additive manufacturing system, comprising:
a support;
a discharge head connected to and moved by the support, the discharge head having:
a wetting mechanism configured to apply a matrix to a continuous reinforcement;
an outlet configured to discharge the matrix-wetted continuous reinforcement; and
a cure enhancer configured to expose the matrix to a cure energy at discharge;
a dispenser mounted to the discharge head and configured to selectively advance particles toward at least one of the matrix and the continuous reinforcement; and
a processor programmed to regulate the dispenser and affect a parameter linked to the particles in a variable manner along at least a length of the continuous reinforcement.

2. The additive manufacturing system of claim 1, wherein the dispenser is configured to advance the particles into the matrix before the continuous reinforcement is wetted with the matrix.

3. The additive manufacturing system of claim 1, wherein the dispenser is configured to advance the particles onto the continuous reinforcement before the continuous reinforcement is wetted with the matrix.

4. The additive manufacturing system of claim 1, wherein the dispenser is configured to advance the particles onto the continuous reinforcement after the continuous reinforcement is wetted with the matrix and before the matrix is exposed to the cure energy.

5. The additive manufacturing system of claim 1, further including a device configured to at least one of position and orient the particles after advancement by the dispenser and prior to exposure of the matrix to the cure energy.

6. The additive manufacturing system of claim 5, wherein the device is configured to at least one of apply heating, cooling, and an electrical field to the particles to affect the at least one of a position and an orientation of the particles.

7. The additive manufacturing system of claim 1, wherein the processor is programmed to regulate the dispenser to advance particles toward the at least one of the matrix and the continuous reinforcement in an amount related to a targeted radio frequency to be absorbed by a structure fabricated from the continuous reinforcement and the matrix.

8. The additive manufacturing system of claim 7, wherein the processor is programmed to regulate the dispenser based on the following formula:
Vc=f(c/f),
wherein:
Vc is a concentration of the particles within a unit volume of the matrix;
c is the speed of light; and
f is the targeted radio frequency to be absorbed.

9. The additive manufacturing system of claim 1, wherein the processor is programmed to also regulate the dispenser and affect the parameter linked to the particles in a variable manner relative to a radial distance from the continuous reinforcement.

10. A method of additively manufacturing a structure, comprising:
wetting a continuous reinforcement with a matrix;
discharging the wetted continuous reinforcement through an outlet of a print head;
moving the print head during discharging;
exposing the matrix to a cure energy during discharging; and
selectively advancing particles toward at least one of the matrix and the continuous reinforcement to affect a parameter of the structure linked to the particles in a variable manner along at least a length of the continuous reinforcement.

11. The method of claim 10, wherein selectively advancing the particles includes selectively advancing the particles into the matrix before the continuous reinforcement is wetted with the matrix.

12. The method of claim 10, wherein selectively advancing the particles includes selectively advancing the particles onto the continuous reinforcement before the continuous reinforcement is wetted with the matrix.

13. The method of claim 10, wherein selectively advancing the particles includes selectively advancing the particles onto the continuous reinforcement after the continuous reinforcement is wetted with the matrix and before the matrix is exposed to the cure energy.

14. The method of claim 10, further including at least one of positioning and orienting the particles after advancement and prior to exposure of the matrix to the cure energy.

15. The method of claim 14, wherein the at least one of positioning and orienting the particles includes at least one of apply heating, cooling, and an electrical field to the particles.

16. The method of claim 10, wherein selectively advancing the particles includes selectively advancing the particles in an amount related to a targeted radio frequency to be absorbed by the structure being additively manufactured from the continuous reinforcement and the matrix.

17. The method of claim 16, wherein selectively advancing the particles includes selectively advancing the particles based on the following formula:
Vc=f(c/f),
wherein:
Vc is a concentration of the particles within a unit volume of the matrix;
c is the speed of light; and
f is the targeted radio frequency to be absorbed.

18. The method of claim 16, wherein the matrix is a thermoset resin and the method includes tuning the thermoset resin for stabilized operation of the structure during transition into and out of the atmosphere.

19. The method of claim 18, wherein tuning the thermoset resin includes adding boron nitride to the thermoset resin.

20. An aircraft additively manufactured via the method of claim 10.
